(19) United States
(12) Patent Application Publication
(10) Pub. No.: US 2009/0267411 A1
(43) Pub. Date: Oct. 29, 2009

(54) REGULATOR

(75) Inventor: TAO WANG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/427,688

(22) Filed: Apr. 21, 2009

(30) Foreign Application Priority Data
Apr. 24, 2008 (CN) 200810301286.1

(51) Int. Cl. B60L 1/08; G05F 3/00; H02H 9/00

(52) U.S. Cl. 307/10.1; 323/304; 361/18

(57) ABSTRACT

A regulator includes a power-converting circuit and a protection circuit. The power-converting circuit is for converting a primary voltage to a secondary voltage. The protection circuit is coupled to the power-converting circuit. The protection circuit receives the primary voltage earlier than the power-converting circuit. When a voltage spike of the primary voltage occurs, the protection circuit shunts the high instantaneous voltage to ground. An electrical device and a car using the regulator is also provided.

### BACKGROUND

1. Technical Field

The present disclosure generally relates to electrical devices, and particularly relates to a regulator for an electrical device.

2. Description of Related Art

Regulators are used in electrical systems to regulate voltages from power sources to one or more components of the systems. However, voltage spikes, due to uncontrolled circumstances, may occur and damage vulnerable components or devices. For example, during operation of a car, sudden braking or sharp turning may produce voltage spikes and damage or destroy pertinent electrical modules of the car.

Therefore, a regulator is needed in the industry to address the aforementioned deficiency.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic block diagram showing an operating system of a car including a regulator in accordance with an exemplary embodiment.

FIG. 2 is a schematic block diagram showing a detailed structure of the regulator.

### DETAILED DESCRIPTION

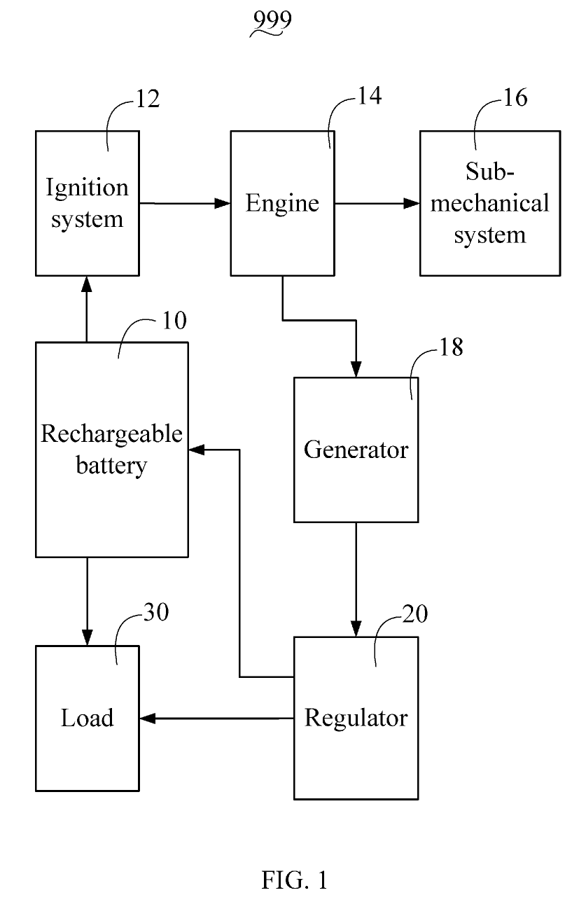

Referring to FIG. 1, in a car 999 in accordance with an exemplary embodiment, a rechargeable battery 10 supplies power to an ignition system 12 for initially turning over the engine 14. After this initial turn over, the engine 14 runs independently on a second power source, such as gas. The engine 14 provides a driving force to a sub-mechanical system 16 of the car 999 and powers the generator 18. Until the engine 14 is turned off, the generator 18 is the primary producer or generator of power that powers the car 999. This primary voltage is used to charge the rechargeable battery 10 via a regulator 20, as needed. As mentioned above, the primary voltage powers other electrical components of the car 999 via the regulator 20, the other electrical components are shown as load 30. The regulator 20 needs to convert the primary voltage to a secondary voltage at a predetermined ratio. The secondary voltage should not exceed the rated voltages, or otherwise the rechargeable battery 10 and the load 30 will be damaged.

In practice, if incidents such as sudden braking or sharp turning occur, voltage from the generator 18 may spike, and a high instantaneous voltage is generated as the secondary voltage. In the embodiment, the regulator 20 protects the rechargeable battery 10 and the load 30 from the high instantaneous voltage. The regulator 20 can also be used in other electrical devices.

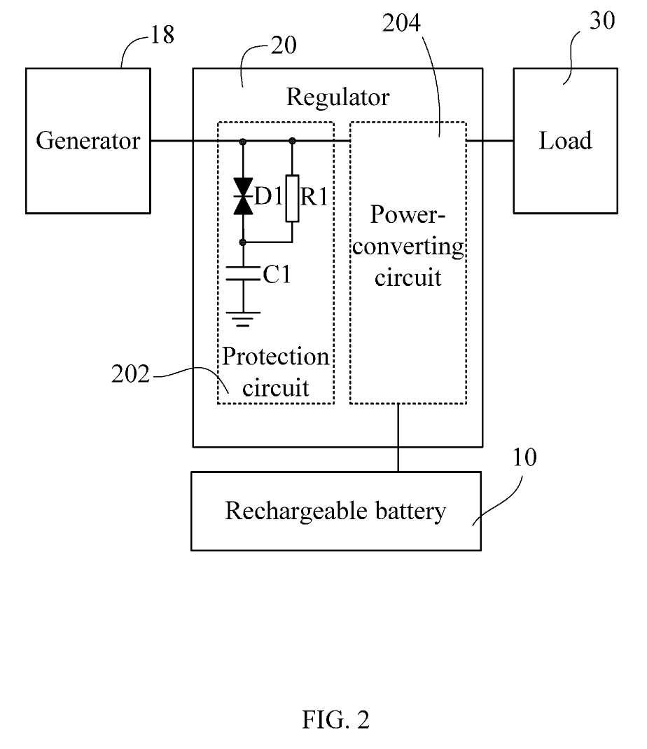

Referring to FIG. 2, the regulator 20 includes a protection circuit 202 and a power-converting circuit 204. The power-converting circuit 204 is coupled to a positive output of the generator 18.The protection circuit 202 is coupled between the generator 18 and the power-converting circuit 204. The protection circuit 202 is capable of shunting the high instantaneous voltage that may be generated by the generator 18 during operation of the car 999 thereby protecting the power-converting circuit 204, the rechargeable battery 10, and the load 30. After the high instantaneous voltage and the generator 18 return to normal operation, power converting operations of the regulator 20 also returns to normal, and the secondary voltage will not have exceeded the rated voltage of the load 30.

The protection circuit 202 includes a transient voltage suppression (TVS) diode D1, a resistor R1, and a capacitor C1. The TVS diode D1 is chosen for having a breakdown voltage in a range that will conduct as soon as a maximum safe voltage of a system being regulated is exceeded. One terminal of the TVS diode D1 is coupled to the positive output of the generator 18, and the other terminal of the TVS diode D1 is coupled to a terminal of the capacitor C1 The other terminal of the capacitor C1 is grounded. The resistor R1 is coupled in parallel with the TVS diode D1.

Under normal conditions, the generator 18 supplies a stable voltage to the regulator 20. While the voltage remains is below the breakdown voltage of the TVS diode D1, the TVS diode D1 does not conduct, and the power-converting circuit 204 operates normally. During operation of the car 999, should there be any spike in voltage from the generator 18 greater than the breakdown voltage of the TVS diode D1, the TVS diode D1 will conduct and shunt the high instantaneous voltage to ground via the capacitor C1. At that time, the diode D1 acts as a short circuit and bypasses the resistor R1. Therefore, the spike is grounded. Moreover, in practice, reverse currents occurring because of coils or transistors in the power-converting circuit 204 when it is powered off can be absorbed by the capacitor C1.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A regulator comprising:
a power-converting circuit for converting a primary voltage to a secondary voltage; and
a protection circuit coupled to the power-converting circuit and receiving the primary voltage earlier than the power-converting circuit, the protection circuit comprising a transient voltage suppression (TVS) diode;
wherein when a voltage spike occurs in the primary voltage, the TVS diode shunts the high instantaneous voltage to ground.

2. The regulator according to claim 1, wherein the protection circuit further comprises a capacitor coupled between the TVS diode and ground.

3. The regulator according to claim 2, wherein the protection circuit comprises a resistor parallelly coupled to the TVS diode.

4. An electrical device comprising:
a power supply for supplying a primary voltage;
a load for consuming a secondary voltage;
a regulator for converting the primary voltage to the secondary voltage, the regulator comprising:
a power-converting circuit coupled between the power supply and the load; and
a protection circuit coupled to the power-converting circuit and receiving the primary voltage earlier than the power-converting circuit, the protection circuit comprising a transient voltage suppression (TVS) diode;
wherein when a spike occurs in the primary voltage to generate a high instantaneous voltage, the TVS diode shunts the high instantaneous voltage to ground.

5. The electrical device according to claim 4, wherein the power-converting circuit is coupled to a positive output of the power supply.

6. The electrical device according to claim 5, wherein the protection circuit is also coupled to the positive output of the power supply.

7. The electrical device according to claim 4, wherein the protection circuit comprises a capacitor coupled between the TVS diode and ground.

8. The electrical device according to claim 7, wherein the protection circuit comprises a resistor parallelly coupled to the TVS diode.

9. A car comprising:
a generator for supplying a primary voltage;
a load for consuming a secondary voltage;
a regulator for converting the primary voltage to the secondary voltage, the regulator comprising:
a power-converting circuit coupled between the power supply and the load; and
a protection circuit coupled to the power-converting circuit and receiving the primary voltage earlier than the power-converting circuit, the protection circuit comprising a transient voltage suppression (TVS) diode;
wherein when a spike occurs in the primary voltage to generate a high instantaneous voltage, the TVS diode shunts the high instantaneous voltage to ground.

10. The car according to claim 9, further comprising an engine for powering the generator.

11. The car according to claim 10, further comprising an ignition system for initially turning over the engine.

12. The car according to claim 10, further comprising a sub-mechanical system for receiving a driving force from the engine.

13. The car according to claim 12, further comprising a rechargeable battery for supplying power to the ignition system and for being charged by the primary voltage.

14. The car according to claim 9, wherein the protection circuit comprises a capacitor coupled between the TVS diode and ground.

15. The car according to claim 14, wherein the protection circuit comprises a resistor parallelly coupled to the TVS diode.
